(19) United States
(12) Patent Application Publication
(10) Pub. No.: US 2006/0152885 A1
(43) Pub. Date: Jul. 13, 2006

(54) Tactile sensor assembly

(76) Inventors: James Robert Hewit, Dundee (GB); Alan P Slade, Dundee (GB); Mark S Pridham, Dundee (GB); Robert P Keatch, Dundee (GB)

Correspondence Address: GIFFORD, KRASS, GROH, SPRINKLE & CITKOWSKI, P.C, PO BOX 7021, TROY, MI, 48007-7021, US

(21) Appl. No.: 10/560,520

(22) PCT Filed: Jun. 11, 2004
(86) PCT No.: PCT/GB04/02524

§ 371 Date: Dec. 13, 2005

(30) Foreign Application Priority Data
Jun. 14, 2003 (GB) 0313794.0

(51) Int. Cl. H01G 7/00

(52) U.S. Cl. 361/283.1

(57) ABSTRACT

There is disclosed a tactile sensor assembly, as well as a palpation assembly and a tactile probe each incorporating the tactile sensor assembly. The tactile sensor assembly has a particular use in surgery, such as minimal access surgery. In one embodiment, a tactile sensor assembly (10) is disclosed which includes a force transmission member (20) and a sensor (18), wherein the force transmission member (20) includes a plurality of projections (22) for transmitting an applied force to the sensor (18), and wherein the sensor (18) is adapted to detect said applied force and to output a signal indicative thereof.

The present invention relates to a tactile sensor assembly, and to a palpation assembly and a tactile probe incorporating the tactile sensor assembly. In particular, but not exclusively, the present invention relates to a tactile sensor assembly for use in surgery, such as minimal access surgery.

Surgeons have the need to identify the condition of body organs and tissue to determine whether they are healthy. This is normally done by the use of their tactile senses, that is they “palpate” the organ or tissue, often by squeezing and rubbing. They then analyse the results subjectively using their knowledge and skill. This process of intelligent palpation cannot be undertaken, in particular, during minimal access surgery (MAS). In MAS, the surgeon performs surgical procedures using long, slender instruments, which are passed into the body through small access wounds. Whilst this has undoubted benefits to the patient, in that the invasiveness of such procedures is much reduced, the surgeons are unable to get their fingers inside the body cavity due to the restricted access available. Thus there has been a considerable effort to try to return this useful sense of touch to minimal access surgeons by artificial means.

Most researchers have approached the field of artificial tactile sensing by trying to find a direct emulation of the way the surgeon works and have attempted to develop large arrays of elements, each capable of transducing the contact forces and pressure distributions set up between the touched surface and the sensing elements. This has proved to be very difficult due to the need to design very small, very sensitive and very robust elements. The elements comprising the array must also be safe to insert into the body cavity.

Ohka discloses an experimental system incorporating an array of small conical projections provided between a rubber sheet and a light guide, where the area of contact of the conical projections increases in proportion to contact pressure of an object. The distribution of contact pressure is obtained by photographing the projections using a camera and measuring the distribution of luminance, that is, reflection caused by contact of the projections with the light guide.

However, the ability of the camera to capture an image of the projections in a real-life environment where the object is very small would be problematic. Furthermore, there would be a requirement for both a light guide fibre for illumination purposes, and an image guide fibre to carry the viewed image to a remote camera system. This would require complex, expensive and bulky fibre bundles. There would also be a requirement to clean the camera and the light guide and to avoid image obscuring or blurring by, for example, contact with tissue such as vein or artery walls.

Eltaib et al and subsequently published US patent publication No. 2002-0112547-A1 disclose a tactile probe including a capacitive pressure sensor with a domed rubber cover. The sensor is placed in contact with an object and reciprocated to apply force to the object and the sensor measures the change in capacitance caused by the applied force and outputs a voltage signal.

It is amongst the objects of embodiments of the present invention to obviate or mitigate at least one of the foregoing disadvantages.

According to a first aspect of the present invention, there is provided a tactile sensor assembly comprising:

a force transmission member; and

a sensor;

wherein the force transmission member includes a plurality of projections for transmitting an applied force to the sensor, and wherein the sensor is adapted to detect said applied force and to output a signal indicative thereof.

The force transmission member transmits forces applied on an object to the sensor, which forces are measured by the sensor. The assembly is relatively compact, and is capable of use in surgical procedures, in particular MAS procedures.

Preferably, the projections are tapered and may be conical, for example, truncated or rounded cones. Alternatively, the projections may comprise hemispherical, domed, pyramidical or any other suitable shape projections. Tapered projections allow the force between the object and the sensor to be determined by measuring the area of contact between the projections and the sensor. Thus as the force increases, the area of contact between the projections and the sensor increases due to deformation of the projections.

In an alternative embodiment, the projections may be substantially uniform in cross-section, and may be cylindrical, and the sensor may be adapted to output voltage data indicative of the force exerted between the object and sensor through the projections. Projections of this type are likely to be particularly effective at transmitting a compressive load, but deflection of the projections, such as when a shear force is applied, are likely to be less effectively transmitted compared to tapered projections.

Preferably, the sensor is adapted to output an electrical signal. The sensor may be adapted to measure at least one of compression and deflection of the projections, and preferably is adapted to measure both compression and deflection. Deflection of the projections may be indicative of a shear force, for example, by rubbing the object, enhancing the tactile properties which may be determined using the sensor assembly. The assembly may thus facilitate, for example, detection of abnormalities such as growths, tumours or the like having different tactile properties (density, compressibility) from surrounding areas of the object.

The sensor may comprise a capacitive sensor, and may comprises a tactile sensor of the type commercially available from, for example, Hitachi (Hitachi BMF™), Fujitsu (Fujitsu MBF200™), AuthenTec (AuthenTec FingerLoc™), or Xensor Integration (Xensor Integration IFS™) The capacitive sensor measures a capacitance value formed when the projections of the force transmission member and the sensor come into contact and produces a voltage output. A larger capacitance is measured in areas of increased contact between the projections and the sensor, due to a force being applied to the object and therefore being transmitted to the sensor, than in areas where there is minimal or no contact due to minimal or no force being applied to the object and therefore being transmitted to the sensor. When a force is exerted, the projections are compressed/deflected, increasing the area of contact between the projections and the sensor. This causes a corresponding increase in the capacitance measured by the sensor, and variations in the measured capacitance are thus indicative of variations in the tactile properties of the object. The sensor may be adapted to output data indicative of deformation of the projections, which data may be converted typically using suitable software, to generate an image of the deformed projections. This may allow the type of deformation of the projections to be viewed (eg, compression and/or deflection) and the forces experienced by the projections to be determined.

Alternatively, the sensor may be adapted to output data indicative of the force between the object and the sensor. For example, the sensor may generate voltage data corresponding to the capacitance between the projections and the sensor, and may output data indicative of a corresponding force, or may output the voltage data for subsequent conversion by a processor of the like into data indicating the force exerted on the sensor through the projections.

Preferably, the assembly includes a processor for receiving data from the sensor. Where the sensor outputs data indicative of deformation of the projections, the processor may be adapted to measure the deformation to determine the distribution of force between the projections (and thus the object) and the sensor. Alternatively, where the sensor outputs data indicative of the force between the object and the sensor, the processor may be adapted to process the data and to generate an output indicative of the distribution of force between the projections and the object. The processor may form part of a Personal Computer (PC). The assembly may include a display and the display may be coupled to the sensor, for displaying an image of the projections. By coupling the display to the sensor, data may be transmitted directly from the sensor to the display. This avoids the requirement for a camera or other image capturing device intermediate of the sensor and the display. The image generated may be indicative of deformation of the projections and the processor may include suitable software for measuring deformation of the projections (relative to an undeformed or starting configuration of the projections), to determine the force exerted between the object and the sensor. The processor and display may be provided together or as separate components.

Preferably, the display is electrically coupled to the sensor, either directly, for example, by a data link such as a fibre optic, metal or other cable or wire, or indirectly, for example, by a radio or other frequency transmitter and receiver assembly. The sensor may therefore be coupled to a radio transmitter for sending data to a remote transmitter coupled to the display. This avoids the requirement for a data link cable extending between the sensor and the display.

Preferably, the number of projections per unit area is maximised, and the force transmission member may comprise at least 100 projections per square centimetre. This provides a large number of projections per unit area, thereby optimising the force data obtained, by the sensor.

The force transmission member is preferably of an elastically deformable material and may be of a plastics material, such as polyvinyl chloride (PVC), a rubber or any other suitable material.

According to a second aspect of the present invention, there is provided a palpation assembly comprising:

a tactile sensor assembly including a force transmission member and a sensor, wherein the force transmission member includes a plurality of projections for transmitting an applied force to the sensor, and wherein the sensor is adapted to detect said applied force and to output a signal indicative thereof; and

at least one palpation member for palpating the object.

The palpation member may be adapted to palpate the object between the palpation member and the force transmission member. The palpation member may comprise an arm, finger, jaw or the like adapted to exert a force on the object to palpate the object. The palpation member is preferably moveably mounted relative to the force transmission member and may be adapted for movement towards and away from the sensor, and in a lateral plane relative to the sensor. The ability to move in this fashion allows both a compressive and a shear (rubbing) force to be exerted on the object. The palpation member and the force transmission member may be independently moveable relative to each other. The assembly may comprise a plurality of palpation members. This may enhance the ability to manipulate the object to determine tactile properties thereof.

It will be understood that references herein to palpate, palpation and palpating of an object are to the examination of an object by manipulation/touching.

According to a third aspect of the present invention, there is provided a tactile probe comprising:

a tactile sensor assembly adapted for movement with respect to an object, the tactile sensor assembly including a force transmission member and a sensor, wherein the force transmission member includes a plurality of projections for transmitting an applied force to the sensor, and wherein the sensor is adapted to detect said applied force and to output a signal indicative thereof.

Further features of the tactile sensor assemblies of the palpation assembly and the tactile probe are defined above.

According to a fourth aspect of the present invention, there is provided a method of detecting tactile properties of an object, the method comprising the steps of:

providing a tactile sensor assembly comprising a force transmission member and a sensor, the force transmission member having a plurality of projections for transmitting an applied force to the sensor;

locating the force transmission member in contact with the object;

moving at least one of the object and the force transmission member relative to the other to compress at least one of the projections, to transmit a force to the sensor; and

outputting a signal from the sensor indicative of the applied force.

Preferably, the method comprises measuring deformation of the projections to determine tactile properties of the object. The method may also or alternatively comprise measuring deflection of the projections.

The object may be palpated to exert a force on the sensor. Alternatively, the force transmission member may be brought into contact with the object and moved relative to the object to exert a force on the sensor.

The method may comprise displaying an image of the projections. This may facilitate measurement of deformation of the projections using a processor. A display may be coupled to the sensor for receiving data from the sensor.

According to a fifth aspect of the present invention, there is provided a method of palpating an object, the method comprising the steps of:

providing a tactile sensor assembly comprising a force transmission member and a sensor, the force transmission member having a plurality of projections for transmitting an applied force to the sensor;

locating the force transmission member in contact with the object;

palpating the object to compress at least one of the projections, to transmit a force to the sensor; and

outputting a signal from the sensor indicative of the applied force.

The method may comprise displaying an image of the projections. This may facilitate measurement of deformation of the projections using a processor. A display may be coupled to the sensor for receiving data from the sensor.

It will be understood that the tactile sensor assembly may have utility in a wide range of fields, in general, in any field where it is desired to obtain data regarding the magnitude, distribution and the like of a force exerted between an object and a sensor. For example, the tactile sensor assembly may have a particular utility in the field of robotics, by facilitating tactile sensing in robots, robotic machinery and other automated equipment. Additional uses are in surgical procedures, generally in the field of medicine and games or simulations such as interactive computer games.

Embodiments of the present invention will now be described, by way of example only, with reference to the accompanying drawings, in which:

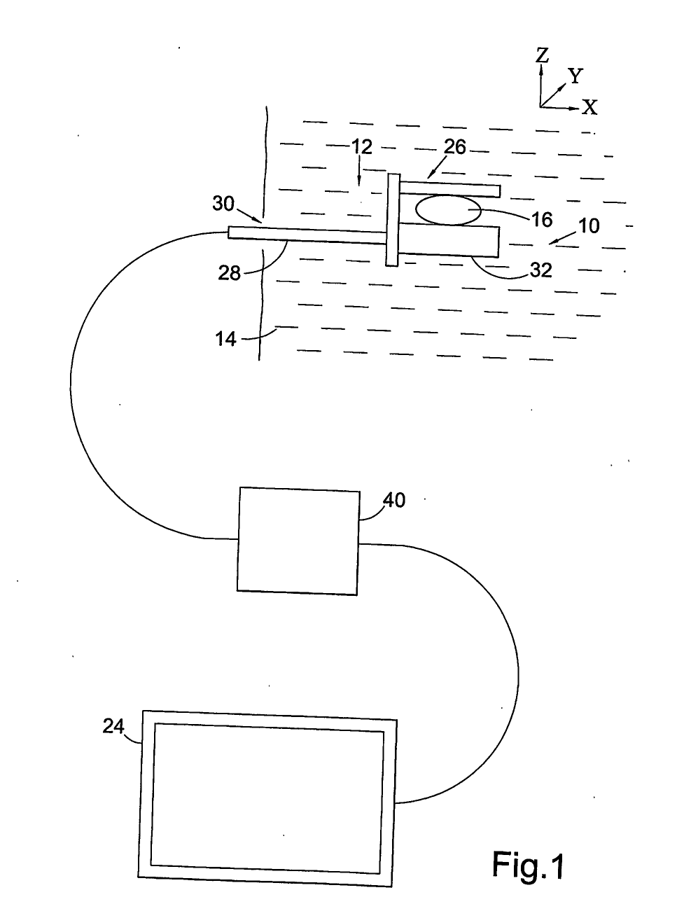

FIG. 1 is a schematic illustration of a tactile sensor assembly and a palpation assembly including the tactile sensor assembly, in accordance with an embodiment of the present invention;

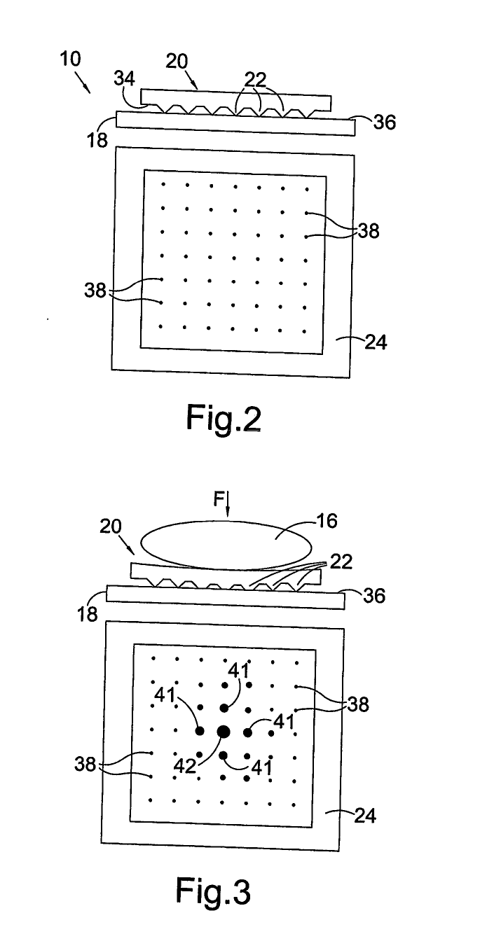

FIG. 2 is an enlarged view of part of the tactile sensor assembly of FIG. 1;

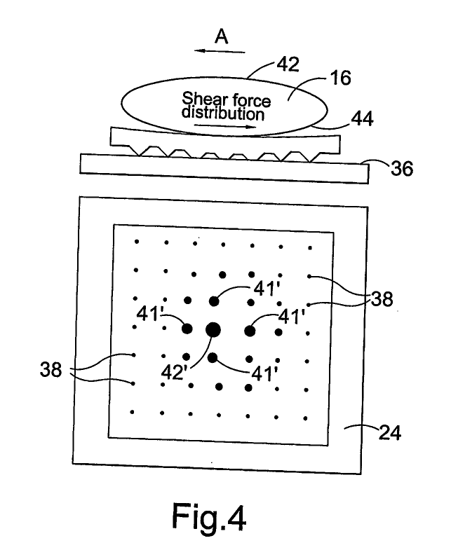

FIGS. 3 and 4 are views of the part of the tactile sensor assembly of FIG. 2, shown in use; and

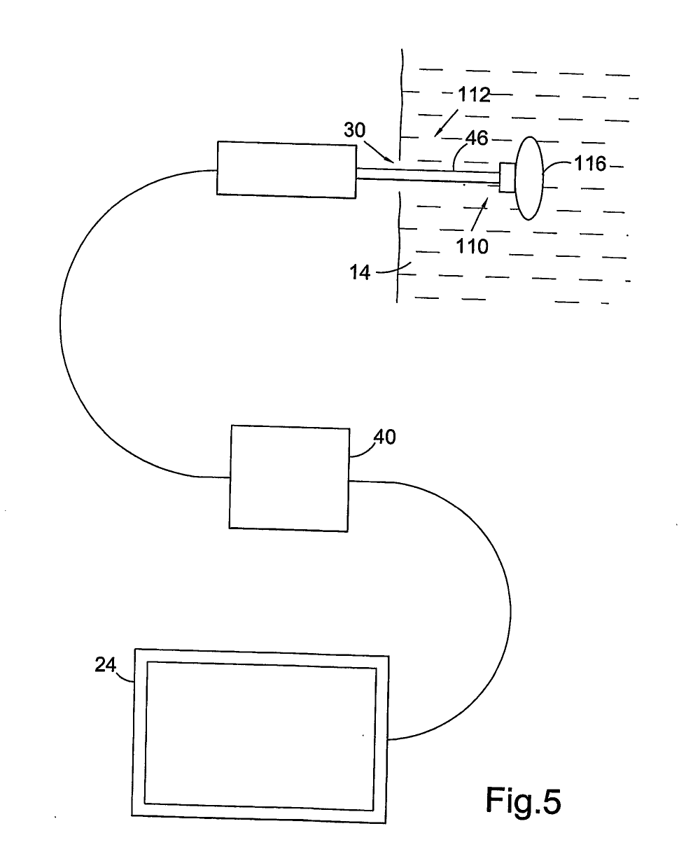

FIG. 5 is a schematic illustration of a tactile sensor assembly and a tactile probe including the tactile sensor assembly, in accordance with an alternative embodiment of the present invention.

Turning firstly to FIG. 1, there is shown a schematic illustration of a tactile sensor assembly in accordance with an embodiment of the present invention, the sensor assembly indicated generally by reference numeral 10. The sensor assembly 10 forms part of a palpation assembly 12, which is shown in FIG. 1 during a MAS procedure, located within the body 14 of a patient. The sensor assembly 10 is used to determine certain tactile properties of a body part 16 by manipulation of the body part in the MAS procedure. This provides a surgeon with information relating to the tactile properties of the body part 16, such as the relative density and compressibility of the body part.

There follows a more detailed description of the sensor assembly 10 and the palpation assembly 12 with reference also to FIGS. 2, 3 and 4. The method of operation of the sensor assembly 10 and the palpation assembly 12 will also be described in more detail.

Turning now to FIG. 2, which is an enlarged view of part of the sensor assembly 10 of FIG. 1, the sensor assembly includes a sensor 18 and a force transmission member 20 having a plurality of conical projections 22 for transmitting a force between an object (body part 16) and the sensor 18. The member 20 typically includes around one hundred projections per square centimetre, in a 10×10 array, but may include a greater or lesser number, if desired. The sensor 18 is optionally coupled to a display 24 (FIG. 1) such as a visual display unit (VDU), for displaying an image corresponding to the force exerted between the sensor 18 and the body part 16.

A force exerted by the body part 16 (typically an organ, vein, artery, part of the intestine/bowel or other tissue) on the sensor 18 is transmitted through the projections 22, thereby compressing selected ones of the projections. This compression of the projections 22 is ultimately viewed on the VDU 24 by the surgeon, providing the surgeon with an indication of the tactile properties of the body part 16 not otherwise possible in a MAS procedure.

The sensor assembly 10, which forms part of the palpation assembly 12, includes a palpation member in the form of an arm 26 moveably mounted with respect to the sensor assembly 10. The palpation assembly 12 is shown in exaggerated schematic form in FIG. 1, and includes a rod or tube 28 for inserting the assembly into the patient's body 14 through a small incision 30. The palpation arm 26 is moveable in three planes of motion XY, XZ, YZ (FIG. 1) relative to the sensor assembly 10, and can thus compress or squeeze the body part 16, and can also rub the body part to exert a shear force, as will be described below.

The sensor assembly 10 also includes a housing 32 within which the sensor 18 and the force transmission member 20 are mounted. The sensor 18 is a tactile sensor of the type commercially available from, for example, Hitachi (Hitachi BMF™), Fujitsu (Fujitsu MBF200™), AuthenTec (AuthenTec FingerLoc™), or Xensor Integration (Xensor Integration IFS™). The force transmission member 20 typically comprises an elastically deformable sheet of a plastics material, such as PVC. The projections 22 are conical and are formed integrally with the sheet 20 and evenly spaced on the sheet lower surface 34 in contact with an upper surface 36 of the sensor 18.

The sensor 18 is a capacitative sensor which includes a number of capacitors which measure capacitance between an upper surface 36 of the sensor and the area adjacent the upper surface. A larger capacitance value is measured where there is physical contact between a body or object and the upper surface 36 of the sensor 18 than where there is no contact. This is because when there is no contact, the capacitance measured is that of surrounding air or other gases, which is negligible. The sensor 18 thus measures the capacitance between the projections 22 and the upper surface 36 of the sensor, and the measured capacitance increases when the projections are deformed to contact the sensor surface 36 over a larger area, as will be described below.

The number of capacitors in the sensor is, typically, greater than the number of projections 22 on the sheet 20. This ensures that an accurate picture of contact between the projections 22 and the upper surface 36 of the sensor, and thus deformation of the projections, is achieved.

FIG. 2 illustrates the points of contact 38 between the conical projections 22 and the sensor as viewed on the VDU 24 prior to palpation of the body part 16. The capacitance measurements taken by the sensor 18 are converted by a processor 40 into a visual display indicating the area of contact between the object and the sensor, which is viewed on the VDU 24.

In use, during palpation of the body part 16, a force F is exerted on the bowel 16 by the palpation arm 26, as shown in FIG. 3. This force is transmitted to the sensor 18 via the conical projections 22 of the sheet 20, causing some of the projections to deform elastically to form truncated cones, as shown in FIG. 3. The area of contact between the projections and the upper surface 36 of the sensor 18 thus increases according to the magnitude of the force F exerted upon the body part 16, and upon the physical properties of the body part.

Relatively dense areas of the body part 16 are less easily deformed and thus transmit a relatively large force through the projections 22 to the sensor 18. Accordingly, the projections 22 in the region of the dense areas are compressed to a greater extent, causing a larger surface area of contact with the sensor 18, as indicated by the numerals 41, 42 in FIG. 3. This larger area of contact thus causes a greater capacitance value to be measured by the sensor 18 in these area of greater contact.

The processor 40, which typically forms part of a personal computer (PC) or other dedicated processor, measures the surface area of contact between the deformed projections 22 and the sensor 18 relative to the undeformed points of contact 38. The processor, using suitable software, calculates the force applied to produce such a deformation and provides a separate display indicative of the applied force. Armed with this information, the surgeon can determine tactile properties of the body part 16 using his skill and knowledge.

FIG. 4 illustrates the bowel 16 during squeezing and rubbing of the body part 16, where a surface 42 of the bowel 16 is moved in the direction of the arrow A by the palpation arm 26, the opposite surface 44 remaining in contact with the sheet 22. This movement causes a lateral deflection or translation of the cones in the direction of the arrow A. This is illustrated by the areas of contact 41′, 42′ of the conical projections 22, which are displaced laterally relative to the undeformed points of contact 38, as illustrated by the image seen on the VDU 24 shown in FIG. 4. The processor 40 measures the displacement of the projections during this shearing or rubbing motion, to further facilitate determination of tactile properties of the bowel 16.

In an alternative embodiment, capacitance data obtained by the sensor 18 is represented by a voltage signal outputted to the processor 40, the voltage data indicative of the magnitude of the force exerted on the sensor 18. This data is outputted by the processor 40 as a display such as a map or graph, to provide the surgeon with an indication of the force transmitted through the sheet 22 to the sensor 18, to further assist in determination of tactile properties of the bowel 16.

Turning now to FIG. 5, there is shown a schematic illustration of a tactile sensor assembly indicated generally by reference numeral 110, forming part of a tactile probe 112. The sensor assembly 110 is similar to the assembly 10 of FIGS. 1-4, and like components share the same reference numerals incremented by 100, as do components of the tactile probe 112 similar to those of the palpation assembly 12.

The tactile probe 112 includes an elongate probe 46 on which the sensor assembly 110 is mounted, for insertion into the patient' s body 14 through the incision 30. The sensor assembly 110 is of the same structure as the assembly 10 illustrated in FIG. 2, and a surface of the sensor assembly is brought into contact with a body part, such as an organ 116. A force is then exerted through the probe 46 to determine tactile properties of the organ in the fashion described above. The tactile probe 112 is typically mounted on a robotic arm for movement with respect to the organ 116, but may alternatively be hand-held.

Various modifications may be made to the foregoing without departing from the spirit and scope of the present invention.

For example, the sensor may be adapted to output data indicative of the force between the object and the sensor. The sensor may output voltage data corresponding to the capacitance between the projections and the sensor, the output voltage indicating the force applied on the sensor through the projections.

Where the sensor outputs data indicative of the force on the sensor, the processor may be adapted to process the data and to generate an output indicative of the distribution of force between the projections and the object.

The display may coupled to the sensor by a fibre optic, metal or other cable or wire, or indirectly, for example, by a radio or other frequency transmitter and receiver assembly. The sensor may therefore be coupled to a radio transmitter for sending data to a remote transmitter coupled to the display.

The projections may comprise hemispherical, domed, pyramidical or any other suitable shape projections. In a further alternative, the projections may be substantially uniform in cross-section, and may be cylindrical, and the sensor may be adapted to output voltage data indicative of the force exerted on the sensor through the projections.

1. A tactile sensor assembly comprising:
a force transmission member; and
a sensor comprising a capacitive sensor;
wherein the force transmission member includes a plurality of deformable projections operative to engage and transmit an applied force to the capacitive sensor, the capacitive sensor being operative to measure a capacitance value formed when the deformable projections are deformed by engagement with the capacitive sensor when a force is applied to the transmission member, and to output a signal indicative thereof.

2. An assembly as claimed in claim 1, wherein the area of engagement between the deformable projections and the capacitive sensor increases in accordance with increasing applied force.

3. An assembly as claimed in claim 1, wherein the force transmission member is operative to transmit forces applied on an object to the sensor.

4. An assembly as claimed in claim 1, wherein the assembly is adapted for use in surgical procedures.

5. An assembly as claimed in claim 4, wherein the assembly is adapted for use in minimal access surgery (MAS) procedures.

6. An assembly as claimed in claim 1, wherein the projections are tapered.

7. An assembly as claimed in claim 6, wherein the projections are conical.

8. An assembly as claimed in claim 1, wherein the projections are substantially uniform in cross-section.

9. An assembly as claimed in claim 8, wherein the projections are cylindrical.

10. An assembly as claimed in claim 1, wherein the sensor is operative to output an electrical signal.

11. An assembly as claimed in claim 1, wherein the sensor is operative to measure at least one of compression and deflection of the projections.

12. An assembly as claimed in claim 1, wherein the sensor is operative to output data indicative of a degree of deformation of at least one of the projections, to facilitate generation of an image of said at least one deformed projection.

13. An assembly as claimed in claim 1, wherein the sensor is operative to output data indicative of a force between the object and the sensor.

14. An assembly as claimed in claim 13, wherein the sensor is operative to generate voltage data corresponding to the capacitance between the projections and the sensor, and to output data indicative of a corresponding force.

15. An assembly as claimed in claim 13, wherein the sensor is operative to generate voltage data corresponding to the capacitance between the projections and the sensor, and to output voltage data for subsequent conversion by a processor into data indicating the force exerted on the sensor through the projections.

16. An assembly as claimed in claim 1, further comprising a processor for receiving data from the sensor.

17. An assembly as claimed in claim 16, wherein the sensor is operative to output data indicative of a degree of deformation of at least one of the projections, to facilitate generation of an image of said at least one deformed projection, and wherein the processor is operative to determine a distribution of force between the projections and the sensor.

18. An assembly as claimed in claim 16, wherein the sensor is operative to output data indicative of a force between the object and the sensor, and wherein the processor is operative to process the data and to generate an output indicative of a distribution of force between the projections and the object.

19. An assembly as claimed in claim 16, wherein the processor includes software operative to measure deformation of the projections relative to a starting configuration, to determine the force exerted between the object and the sensor.

20. An assembly as claimed in claim 1, further comprising a display coupled to the sensor, for displaying an image of the projections.

21. An assembly as claimed in claim 20, wherein the display is directly coupled to the sensor by a data link cable.

22. An assembly as claimed in claim 20, further including a transmitter and receiver for transmitting data between the display and the sensor, such that the display is indirectly coupled to the sensor.

23. An assembly as claimed in claim 1, wherein the force transmission member includes at least 100 projections per square centimetre.

24. An assembly as claimed in claim 1, wherein the force transmission member is formed of an elastically deformable material.

25. A palpation assembly comprising:
a tactile sensor assembly including a force transmission member and a sensor comprising a capacitive sensor, wherein the force transmission member includes a plurality of deformable projections for transmitting an applied force to the capacitive sensor, the capacitive sensor being operative to measure a capacitance value formed when the deformable projections are deformed by engagement with the capacitive sensor when a force is applied to the transmission member, and to output a signal indicative thereof; and
at least one palpation member for palpating the object.

26. A palpation assembly as claimed in claim 25, wherein the palpation assembly is operative to palpate the object between the palpation member and the force transmission member.

27. A palpation assembly as claimed in claim 25, wherein the palpation member comprises an arm adapted to exert a force on the object to palpate the object.

28. A palpation assembly as claimed in claim 25, wherein the palpation member is moveably mounted relative to the force transmission member and operative to move both towards and away from the sensor and in a lateral plane relative to the sensor.

29. A palpation assembly as claimed in claim 25, wherein the palpation member and the force transmission member are independently moveable relative to each other.

30. (canceled)

31. A tactile probe comprising:
a tactile sensor assembly adapted for movement with respect to an object, the tactile sensor assembly including a force transmission member and a sensor comprising a capacitive sensor, wherein the force transmission member includes a plurality of deformable projections for transmitting an applied force to the capacitive sensor, the capacitive sensor being operative to measure a capacitance value formed when the deformable projections are deformed by engagement with the capacitive sensor when a force is applied to the transmission member, and to output a signal indicative thereof.

32. (canceled)

33. A method of detecting tactile properties of an object, the method comprising the steps of:
providing a tactile sensor assembly comprising a force transmission member and a sensor comprising a capacitive sensor, the force transmission member having a plurality of deformable projections for transmitting an applied force to the capacitive sensor;
locating the deformable projections of the force transmission member in contact with the object;
moving at least one of the object and the force transmission member relative to the other to compress at least one of the deformable projections, to transmit a force to the sensor;
measuring a capacitance value between the compressed deformable projection and the sensor; and
outputting a signal from the sensor indicative of the applied force.

34. A method as claimed in claim 33, further comprising measuring deformation of the projections to determine tactile properties of the object.

35. A method as claimed in claim 33, further comprising measuring deflection of the projections.

36. A method as claimed in claim 33, further comprising palpating the object to exert a force on the sensor.

37. A method as claimed in claim 33, further comprising bringing the force transmission member into contact with the object and moving the force transmission member relative to the object to transmit a force to the sensor.

38. A method as claimed in claim 35, further comprising displaying an image of the projections.

39. A method of palpating an object, the method comprising the steps of:
providing a tactile sensor assembly comprising a force transmission member and a sensor comprising a capacitive sensor, the force transmission member having a plurality of deformable projections for transmitting an applied force to the sensor;
locating the force transmission member in contact with the object;
palpating the object to compress at least one of the projections, to transmit a force to the sensor;
measuring a capacitance value between the compressed deformable projection and the sensor; and
outputting a signal from the sensor indicative of the applied force.
